(19) United States
(12) Patent Application Publication
(10) Pub. No.: US 2007/0151074 A1
(43) Pub. Date: Jul. 5, 2007

(54) Power tool handle

(76) Inventors: Marvin E. Whiteman JR., Boise, ID (US); Timothy S. Jaszkowiak, Boise, ID (US)

Correspondence Address: HOLLAND & MIDGLEY, LLP, P.O. Box 1840, Boise, ID, 83701-1840, US

(21) Appl. No.: 11/324,460

(22) Filed: Jan. 3, 2006

(51) Int. Cl. E05B 1/00

(52) U.S. Cl. 16/110.1

(57) ABSTRACT

The present application is directed to a power tool handle comprising a gripping member and one or more support assemblies. The one or more support assemblies comprise a first support portion coupled to the gripping member and a second support portion having an end part configured to cooperate with a desired height adjustment mechanism. The first and second support portions are coupled together using one or more vibration isolating members. The one or more vibration isolating members are not part of the selected height adjustment mechanism, although the selected height adjustment mechanism may comprise additional vibration isolating members, if desired.

### BACKGROUND

The present application is directed generally to power tool handles, and more particularly, to power tool handles for reducing vibration to the user.

Certain power tools may be operated by a user gripping a handle in order to control the movement and/or functions of the power tool. Examples of such power tools may include tools for finishing cement, such as power trowels. These power tools may impart undesirable vibrations to the user operating the tool.

Power tool handles which reduce or eliminate vibrations to the user during operation of power tools are known in the art. One example of such a handle is found in U.S. Patent Publication 2005/0172457, to Glenn et al., published Aug. 11, 2005. The Glenn patent application discloses a branch handle attached to a main handle of a power trowel at two points, a lower attachment point and an upper attachment point. The upper attachment is typically accomplished using a resilient connection, disclosed as a grommet made of rubber or rubber like material, while the lower connection is typically a solid connection. According to Glenn, the resilient member prevents vibration from being transmitted to the user. However, the Glenn handle does not allow for height adjustment.

### BRIEF DESCRIPTION

The above-mentioned drawbacks associated with existing power tool handles are addressed by embodiments of the present application.

One embodiment of the present application is directed to a power tool handle comprising a gripping member and one or more support assemblies. The one or more support assemblies comprise a first support portion coupled to the gripping member and a second support portion having an end part configured to cooperate with a selected height adjustment mechanism. The first and second support portions are coupled together using one or more vibration isolating members. The one or more vibration isolating members are not part of the selected height adjustment mechanism, although the selected height adjustment mechanism may comprise additional vibration isolating members, if desired.

Another embodiment of the present application is directed to a power trowel handle comprising a height adjustment mechanism configured to be coupled to a main handle of a power trowel, a gripping member, and one or more support assemblies. The height adjustment mechanism comprises a rotational axis. Each support assembly comprises a first support portion coupled to the gripping member and a second support portion coupled to the height adjustment mechanism. The first and second support portions are coupled together using one or more vibration isolating members positioned between the height adjustment mechanism and the gripping member in a manner that allows the coupled first and second support portions to rotate together on the rotational axis.

Another embodiment of the present application is directed to a power trowel comprising a body having powered trowel blades and a power trowel handle. The power trowel handle comprises a main handle coupled to the body, a height adjustment mechanism coupled to the main handle, a gripping member, and one or more support assemblies. The height adjustment mechanism comprises a rotational axis. Each support assembly comprises a first support portion coupled to the gripping member and a second support portion coupled to the height adjustment mechanism. The first and second support portions are coupled together using one or more vibration isolating members positioned between the height adjustment mechanism and the gripping member in a manner that allows the coupled first and second support portions to rotate together on the rotational axis.

The details of one or more embodiments of the present application are set forth in the accompanying drawings and the description below. The features, functions, and advantages can be achieved independently in various embodiments of the present application, or may be combined in yet other embodiments.

### DRAWINGS

FIG. 1 illustrates a power tool handle according to one embodiment of the present application.

FIG. 2 illustrates a partially exploded view of the upper handle of the power tool handle of the FIG. 1 embodiment.

FIG. 3 illustrates a power tool handle according to an embodiment of the present application.

FIGS. 4A and 4B illustrate exemplary vibration isolating members which may be employed in the power tool handles of the present application.

FIGS. 5A and 5B illustrate power tool handles according to certain embodiments of the present application.

FIG. 6 illustrates an exploded view of an upper handle of a power tool, according to an embodiment of the present application.

Where appropriate, like reference numbers and designations in the various drawings represent like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

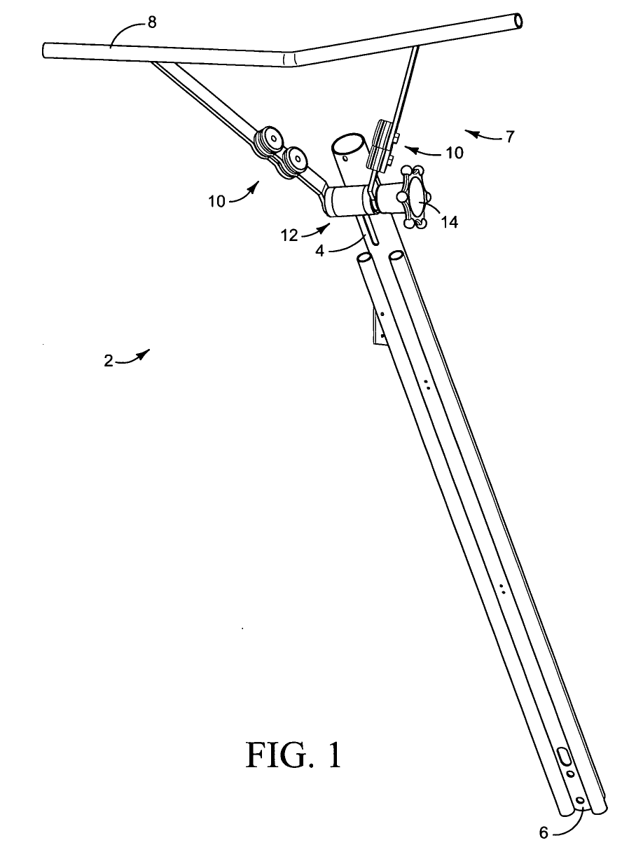

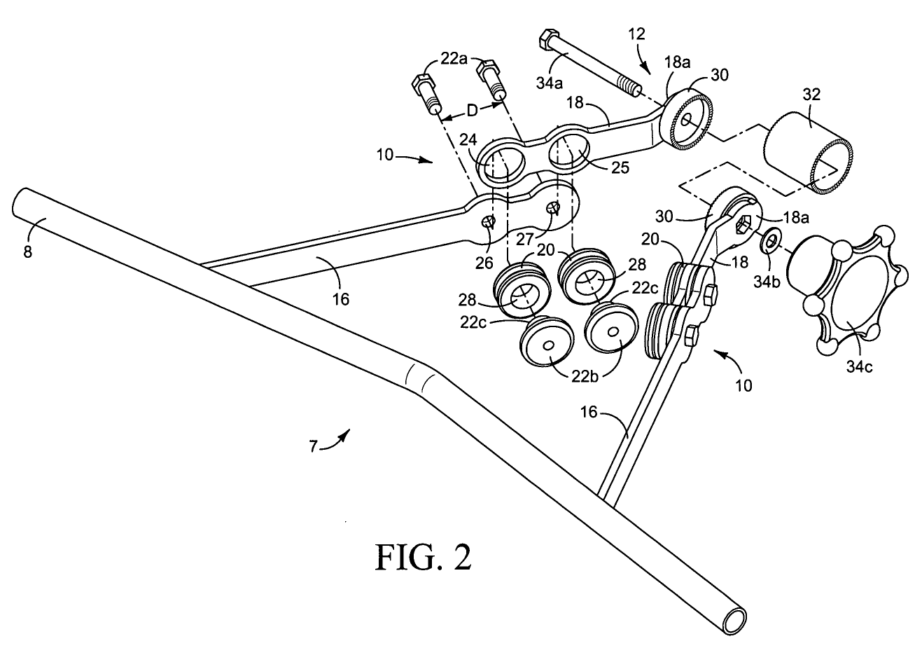

FIG. 1 illustrates a power tool handle 2 according to one embodiment of the present application. Handle 2 comprises a main handle 4, which may be connected to a power tool at end 6, by any suitable means. An upper handle assembly 7, comprising a gripping member 8, support assemblies 10 and an adjustment mechanism 12, is coupled to main handle 4. An exploded view of upper handle assembly 7 is illustrated in FIG. 2.

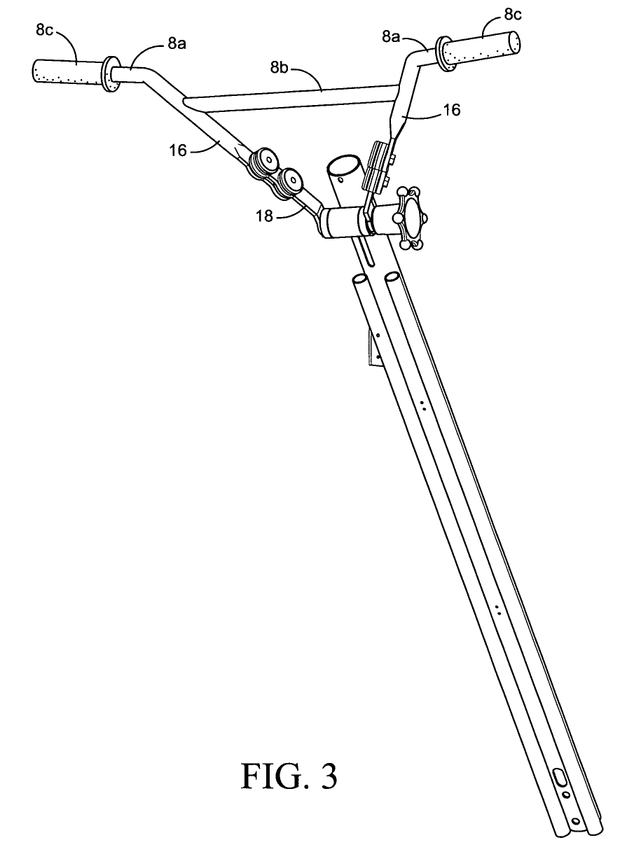

In the illustrated embodiment, gripping member 8 is a length of hollow metal pipe which is angled to allow for easy gripping. However, gripping member 8 need not be an angled hollow metal pipe, but could be made of any other suitable material and/or have any suitable shape and size which would allow the user to grip the gripping member 8 and thereby control the power tool. For example, gripping member 8 may be straight, rather than angled. In another embodiment, gripping member 8 may be a solid piece of metal or plastic having any desired shape suitable for gripping. In yet another embodiment, illustrated in FIG. 3, gripping member 8 may comprise extensions 8a of first support portions 16, and a crossbar 8b attached between the supports 16 for support. In the embodiment of FIG. 3, grip covers 8c are employed, as is well known in the art. Yet other gripping member designs would be readily apparent to one of ordinary skill in the art, and would fall within the scope of the present application.

Support assemblies 10, as illustrated in the embodiment of FIG. 2, each comprise a first support portion 16 and corresponding second support portion 18. Each first support portion 16 extends from gripping member 8. Each second support portion 18 has an end part 18a configured to cooperate with height adjustment mechanism 12. In the illustrated embodiment, first and second support portions 16 and 18 are coupled together using one or more vibration isolating members 20 positioned between end part 18a of each of the second support portions 18 and gripping member 8. In this manner, when the support assemblies 10 are coupled to the adjustment mechanism 12, the vibration isolating members 20 are positioned between the height adjustment mechanism 12 and the gripping member 8 in a manner that allows the coupled first and second support portions 16 and 18 to rotate together on a rotational axis of the height adjustment mechanism 12.

In one embodiment, vibration isolating members 20 may comprise any resilient material suitable for reducing vibration. Examples of suitable resilient materials include rubbers, such as a neoprene. Vibration isolating members 20 may be positioned so as to reduce vibration between each first support portion 16 and each second support portion 18.

In certain embodiments, the one or more vibration isolating members 20 are positioned between the first support portion 16 and second support portion 18, so that the first and second support portions are not in direct contact with each other. Vibration isolating members 20 may also be positioned between fasteners 22, such as bolts 22a and/or nuts 22b, and at least one of first and second support portions 16 and 18. In this manner, vibration isolating members 20 may help to reduce the amount of vibration transmitted from second support portion 18 to first support portion 16 and gripping member 8.

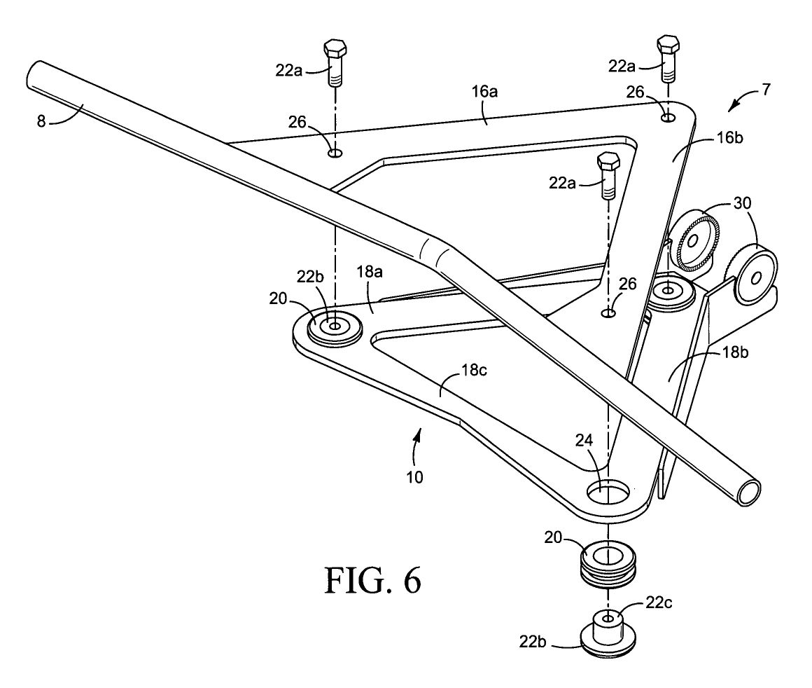

As illustrated in the embodiment of FIG. 2, the vibration isolating members 20 may be in the form of grommets which are positioned through holes 24 and 25 so that vibration isolating members 20 line the inside perimeters of holes 24 and 25 and cover the side portions of second support portion 18 immediately surrounding holes 24 and 25. Vibration isolation members 20 of the FIG. 2 embodiment have holes 28 formed therethrough. Holes 28 are sized to accept a female threaded portion 22c of nut 22b, as is more clearly seen in the embodiment illustrated in FIG. 6, which will be described in greater detail below.

Bolts 22a may be inserted through holes 26 and 27 in first support portion 16 and into female threaded portion 22c of nuts 22b, which are inserted through holes 28 of vibration isolating members 20, thereby allowing support portion 18 to be coupled to support portion 16. In this embodiment, vibration isolating members 20 are positioned so that neither first support portion 16 or fasteners 22 are in direct contact with second support portion 18, thereby reducing the amount of vibration transmitted from second support portion 18 to first support portion 16 during operation.

In an alternative embodiment, holes 24 and 25 for accepting the vibration isolating members 20 may be positioned in first support portion 16, and holes 26 and 27 may be positioned in second support portion 18. In this alternative embodiment, vibration isolating members 20 may be positioned so that neither second support portion 18 or fasteners 22 are in direct contact with first support portion 16.

The distance D between the center of holes 24 and 25 may have an effect on the degree of vibration dampening which is realized in certain embodiments of the present application. For example, in the embodiment of FIGS. 1 and 2, it may be desirable for distance D to be relatively short in order to realize a desired degree of dampening. In one embodiment, the distance D may range, for example, from about 1 inch to about 6 inches, and more preferably from about 2 inches to about 4 inches. In one embodiment, distance, D, is about 3 inches. In yet other embodiments, the distance D may be greater than 6 inches or less than 1 inch.

In the illustrated embodiments, the vibration isolating members 20 are not a part of the adjustment mechanism 12. In alternative embodiments, additional vibration isolating members may be a part of the adjustment mechanism 12, so as to provide a desired degree of vibration dampening between the adjustment mechanism 12 and the second support portions 18. For example, additional grommets, similar to vibration isolating members 20 illustrated in FIGS. 1 and 2, could be positioned in end parts 18a, between end parts 18a and the parts of adjustment mechanism 12.

Support assemblies 10, as illustrated in FIGS. 1 and 2, are representative only, and other designs would be readily apparent to one of ordinary skill in the art, and would fall within the scope of the present application. For example, support portions 16 and 18 are illustrated as flat brackets, but may be any suitable shape. In one exemplary embodiment, support portions 16 and 18 may have a square or circular cross-section. FIG. 3 illustrates one embodiment where a portion of each first support portion 16 has a circular cross-section, while the regions where first support portions 16 are coupled to second support portions 18 are flat, similarly as described above for the embodiments of FIGS. 1 and 2.

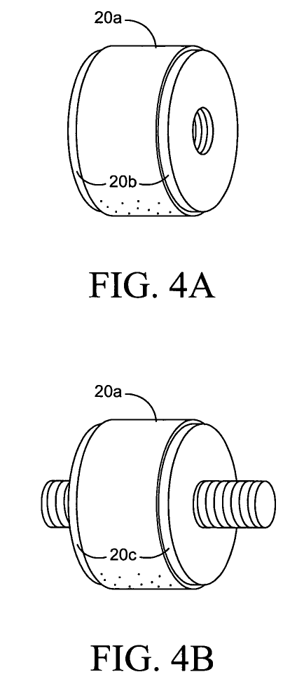

Referring again to FIG. 2, support assemblies 10 may employ any suitable type of vibration isolating members 20. For example, while vibration isolating members 20 in FIGS. 1 and 2 are illustrated as grommets, one of ordinary skill in the art would understand that other types of vibration isolating members known in the art may be used in place of grommets. Examples of other types of suitable, well known vibration isolating members 20 are illustrated in FIGS. 4A and 4B, which each comprise a resilient portion 20a positioned between either female end portions 20b, as shown in FIG. 4A, or male end portions 20c, as shown in FIG. 4B. The two end portions 20b of the FIG. 4A isolating member are not in physical contact, and are separated from each other by the resilient portion 20a. Similarly, the two end portions 20c of the FIG. 4B isolating member are not in physical contact, and are separated from each other by the resilient portion 20a. One of ordinary skill in the art would readily understand how to design support assemblies 10 to employ other types of vibration isolating members, such as those of FIGS. 4A and 4B, so as to achieve the desired vibration dampening effect.

In the illustrated embodiment of FIGS. 1 and 2, two vibration isolating members 20 are used to couple first support portion 16 to second support portion 18. In other embodiments, any suitable number of vibration isolating members 20 may be employed. For example, in one embodiment a single vibration isolation member may be used to couple first support portion 16 to second support portion 18. In yet other embodiments, three or more vibration isolation members may be used to couple first support portion 16 to second support portion 18.

In the embodiment of FIGS. 1 and 2, support portions 18 are coupled to an adjustment mechanism 12, which in turn is coupled to main handle 2. Adjustment mechanism 12 may be any suitable adjustment mechanism capable of allowing the height of gripping member 8 to be adjusted. A number of such adjustment mechanisms, such as serrated bosses, clamp style adjustment mechanisms, and tapered bosses, are well known in the art and may be employed in the embodiments of the present application. For example, Stone Equipment manufactures a trowel, model number CF-364, with a serrated boss style adjustment mechanism; Allen Engineering manufactures a handle, model number AJH, with a clamp style adjustment mechanism; and MBW manufactures a complete trowel, model number F36/4, with a tapered boss style adjustment mechanism. Yet other types of suitable adjustment mechanisms may also be employed.

In the illustrated embodiments, adjustment mechanism 12 is a serrated boss. FIG. 2 illustrates an exploded view of one embodiment of the adjustment mechanism 12, in which the serrated boss comprises two end portions 30 separated by a spacer 32, and a fastener assembly 34. In the illustrated embodiment, the fastener assembly 34 includes a bolt 34a, washer 34b and knob 34c, which comprises a female threaded portion at one end (not shown) for accepting bolt 34a. The two end portions 30 are allowed to rotate relative to spacer portion 32 around a rotational axis of the adjustment mechanism 12 when the fastener assembly 34 is loosened. The two end portions 30 are coupled to support portions 18, while spacer portion 32 is coupled to main handle 2. The height of gripping member 8 may be adjusted as desired by loosening knob 34c, rotating gripping member 8 on the rotational axis of adjustment mechanism 12 to the desired height and then re-tightening knob 34c until upper handle 7 is held in a fixed position by the serrated boss 12.

It certain embodiments it may be desirable to fabricate the upper handle assembly 7 to comprise the gripping member 8 and support assemblies 10, without the adjustment mechanisms 12, or with only a portion of the adjustment mechanism. In these embodiments, end part 18a of second support portion 18 of support assemblies 10 may be configured to cooperate with height adjustment mechanism 12 in any suitable manner. For example, end part 18a may comprise parts of an adjustment mechanism 12, such as end portions 30, as illustrated in the embodiments of FIGS. 2 and 6.

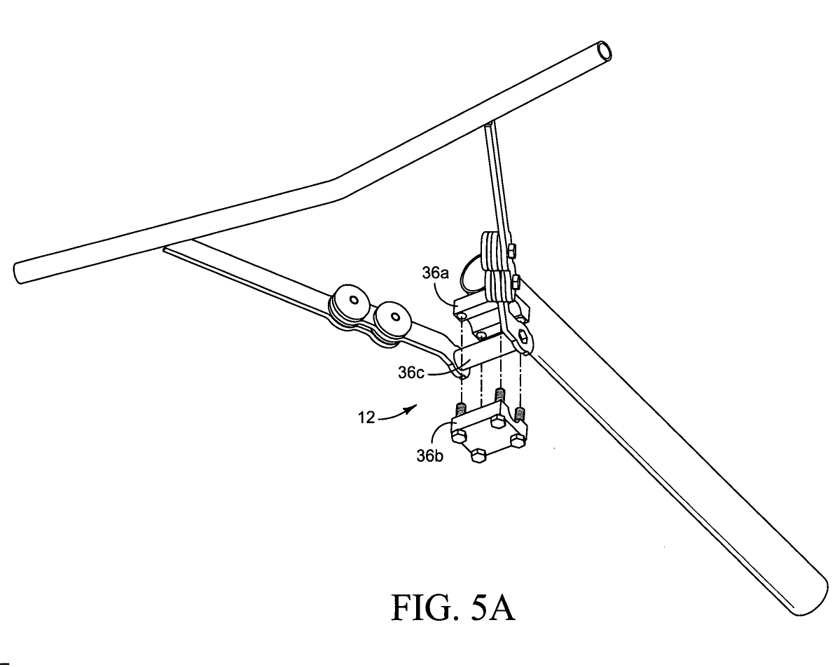

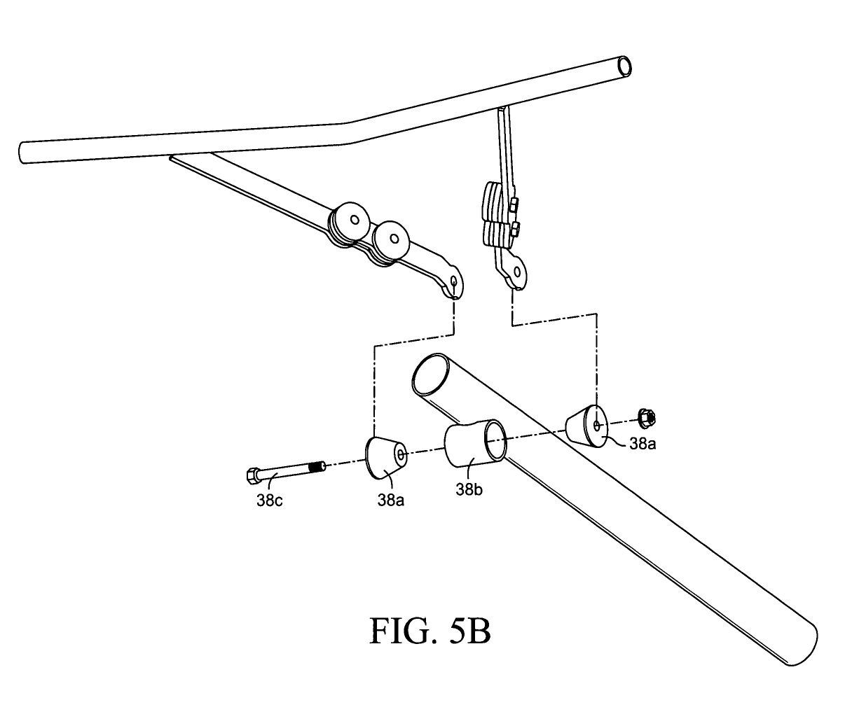

Additional examples of suitable adjustment mechanisms are illustrated in FIGS. 5A and 5B. FIG. 5A illustrates one example of a well known clamp style adjustment mechanism 12, which comprises first and second clamp portions 36a and 36b, which may be clamped around a spacer 36c that is attached to end portions 18a of support portions 18. FIG. 5B illustrates one example of a well known tapered boss adjustment mechanism, comprising tapered portions 38a attached to end portions 18a of support portions 18. The tapered portions 18a may be inserted into opposing ends of spacer 38b and held in place against spacer 38b so as to hold the upper handle assembly in a fixed position when bolt 38c is tightened.

FIG. 6 illustrates another embodiment of an upper handle assembly 7, which comprises a single support assembly 10. Support assembly 10 in the FIG. 6 embodiment comprises a first support portion 16 and corresponding second support portion 18, wherein the first support portion is coupled to a gripping member 8 and the second support portion is configured to cooperate with a height adjustment mechanism, of which only end portions 30 are shown.

In the embodiment of FIG. 6, first support portion 16 comprises two segments 16a and 16b which each connect to gripping member 8 at one end, and meet at a common point at the other end, to form a “V” shape. Second support portion 18 comprises two segments, 18a and 18b, which are shaped so as to align with the two segments of first support portion 16, as well as a third segment 18c which connects the ends of segments 18a and 18b, to form a triangular shape. The first and second support portions 16 and 18 are coupled together via a plurality of vibration isolating members 20 and fasteners 22.

The vibration isolating members 20 are positioned between the first support portion 16 and second support portion 18, so that the first and second support portions 16 and 18 are not in direct contact with each other. The vibration isolating members 20 may also be positioned between the fasteners 22 and at least one of the first and second support portions 16 or 18. In this manner, vibration isolating members 20 may help to reduce the amount of vibration transmitted from second support portion 18 to first support portion 16 and gripping member 8.

For example, as illustrated in the embodiment of FIG. 6, the vibration isolating members 20 may be in the form of grommets which are positioned through holes 24 in second support portion 18 so that vibration isolating members 20 line the inside perimeter of holes 24 and cover the side portions of second support portion 18 immediately surrounding holes 24. In the embodiment of FIG. 6, vibration isolating members 20 are positioned so that neither first support portion 16 or fasteners 22 are in direct contact with second support portion 18.

In an alternative embodiment, holes 24 for accepting the vibration isolating members 20 in the FIG. 6 embodiment may be positioned in first support portion 16, and holes 26 may be positioned in second support portion 18. In this embodiment, vibration isolating members 20 are positioned so that neither second support portion 18 or the fasteners are in direct contact with first support portion 16.

Support assembly 10, as illustrated in FIG. 6, is representative only, and other designs would be readily apparent to one of ordinary skill in the art, and would fall within the scope of the present application. For example, support portions 16 and 18 are illustrated as flat brackets, but may be any suitable shape. In other exemplary embodiments, support portions 16 and 18 may have a square or circular cross-section. In the embodiment where support portions 16 and 18 have a circular cross-section, the regions of support portions 16 and 18 where the vibration isolating members are positioned may be flat, if desired, in order to allow grommets to be employed as the vibration isolating members, similarly as illustrated in FIGS. 1 and 2.

Support assemblies 10 in the embodiment of FIG. 6 may employ any suitable type of vibration isolating members 20. For example, one of ordinary skill in the art would understand that other types of vibration isolating members known in the art may be used in place of grommets to couple support portions 16 and 18 together, including any of the vibration isolating members described above, such as those illustrated in FIGS. 4A and 4B.

In the embodiment of FIG. 6, adjustment mechanism 12 may be any suitable adjustment mechanism capable of allowing the height of gripping member 8 to be adjusted. For example, in place of the serrated boss adjustment mechanism employed in FIG. 6, clamp style adjustment mechanisms and tapered bosses, such as those described above in the description of the embodiments of FIGS. 5A and 5B, may be employed.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A power tool handle, comprising:
a gripping member; and
one or more support assemblies comprising a first support portion coupled to the gripping member and a second support portion having an end part configured to cooperate with a selected height adjustment mechanism;
wherein the first and second support portions are coupled together using one or more vibration isolating members, and
wherein the one or more vibration isolating members are not part of the selected height adjustment mechanism.

2. The power tool handle of claim 1, wherein the end part is configured so as to comprise a portion of the desired height adjustment mechanism.

3. The power tool handle of claim 1, wherein the power tool handle does not comprise the desired height adjustment mechanism.

4. The power tool handle of claim 1, wherein the vibration isolating members are grommets comprising a resilient material.

5. The power tool handle of claim 1, having two of the support assemblies, wherein the first and second support portions of each of the support assemblies are coupled together using two vibration isolating members.

6. The power tool handle of claim 5, wherein the vibration isolating members are positioned in holes in either the first or the second support portions of the support assemblies, the holes having centers that are positioned about 2 inches to about 4 inches apart.

7. The power tool handle of claim 1, having a single support assembly, wherein the first and second support portions of the support assembly are coupled together using a plurality of vibration isolating members.

8. A power trowel handle, comprising:
a height adjustment mechanism configured to be coupled to a main handle of a power trowel, the height adjustment mechanism comprising a rotational axis;
a gripping member; and
one or more support assemblies, each support assembly comprising a first support portion coupled to the gripping member and a second support portion coupled to the height adjustment mechanism,
wherein the first and second support portions are coupled together using one or more vibration isolating members positioned between the height adjustment mechanism and the gripping member in a manner that allows the coupled first and second support portions to rotate together on the rotational axis.

9. The power trowel handle of claim 8, wherein the height adjustment mechanism comprises a serrated boss pivot.

10. The power trowel handle of claim 8, wherein the height adjustment mechanism comprises a clamp style adjustment mechanism.

11. The power trowel handle of claim 8, wherein the height adjustment mechanism comprises a tapered boss pivot.

12. The power trowel handle of claim 8, wherein the vibration isolating members are grommets comprising a resilient material.

13. The power trowel handle of claim 8, having two of the support assemblies, wherein the first and second support portions of each of the support assemblies are coupled together using two vibration isolating members.

14. The power trowel handle of claim 13, wherein the vibration isolating members are positioned in holes in either the first or the second support portions of the support assemblies, the holes having centers that are positioned about 2 inches to about 4 inches apart.

15. The power trowel handle of claim 8, having a single support assembly, wherein the first and second support portions of the support assembly are coupled together using a plurality of vibration isolating members.

16. A power trowel, comprising:
a body having trowel blades and an engine for powering the trowel blades; and
a power trowel handle, the power trowel handle comprising;
a main handle coupled to the body;
a height adjustment mechanism coupled to the main handle, the height adjustment mechanism comprising a rotational axis;
a gripping member; and
one or more support assemblies, each support assembly comprising a first support portion coupled to the gripping member and a second support portion coupled to the height adjustment mechanism,
wherein the first and second support portions are coupled together using one or more vibration isolating members positioned between the height adjustment mechanism and the gripping member in a manner that allows the coupled first and second support portions to rotate together on the rotational axis.

17. The power trowel of claim 16, wherein the vibration isolating members are grommets comprising a resilient material.

18. The power trowel of claim 16, wherein the adjustment mechanism is a serrated boss pivot.

19. The power trowel of claim 16, having two of the support assemblies, wherein the first and second support portions of each of the support assemblies are coupled together using two vibration isolating members.

20. The power trowel of claim 16, having a single support assembly, wherein the first and second support portions of the support assembly are coupled together using a plurality of vibration isolating members.
